(19) United States
(12) Patent Application Publication
(10) Pub. No.: US 2018/0016162 A1
(43) Pub. Date: Jan. 18, 2018

(54) Magnetic Metal Oxide Biochar Composite Particles, and Their Use in Recovering Pollutants From Aqueous Solution

(71) Applicants: Jim J Wang, Baton Rouge, LA (US); Ronghua Li, Yangling (CN); Baoyue Zhou, Baton Rouge, LA (US)

(72) Inventors: Jim J Wang, Baton Rouge, LA (US); Ronghua Li, Yangling (CN); Baoyue Zhou, Baton Rouge, LA (US)

(73) Assignee: Board of Supervisors of Louisiana State University and Agricultural and Mechanical College, Baton Rouge, LA (US)

(21) Appl. No.: 15/628,842

(22) Filed: Jun. 21, 2017

Related U.S. Application Data
(60) Provisional application No. 62/362,901, filed on Jul. 15, 2016.

(51) Int. Cl. C02F 1/28; C01G 49/08; C05F 17/00; C01F 5/00; C10B 53/08; C08K 3/00

(52) U.S. Cl. CPC C02F 1/288; C10B 53/08; C08K 3/0008; C05F 17/0045; C01F 5/00; C02F 1/283; C02F 1/281; C01G 49/08; C02F 2305/08

(57) ABSTRACT

Composite particles are disclosed comprising magnesium oxide, iron oxide, and biochar; and methods of making and using the composite particles. The composite particles may be used to recover solutes including phosphate, nitrate, ammonium, and organic compounds from aqueous solution, and the resulting solute-loaded particles may be used as a fertilizer to enhance plant growth. The composites be used to remove pollutants from agricultural runoff, wastewater, and surface water. The particles possess magnetic properties that enhance their recovery following solute adsorption.

### PRIORITY CLAIM

The benefit of the 15 Jul. 2016 filing date of U.S. provisional patent application Ser. No. 62/362,901 is claimed under 35 U.S.C. §119(e). The complete disclosure of the priority application is hereby incorporated by reference in its entirety.

### STATEMENT REGARDING FEDERALLY SPONSORED RESEARCH

This invention was made with government support under grant number NRCS 69-3A75-10-156 awarded by the United States Department of Agriculture. The United States Government has certain rights in the invention.

### TECHNICAL FIELD

This invention pertains to magnetic magnesium oxide/iron oxide/biochar composite particles, and their use in recovering water-soluble ionic pollutants, such as phosphate, nitrate, ammonium, or dissolved organic compounds.

### BACKGROUND ART

Phosphate

Phosphate is an essential plant nutrient, commonly found in agricultural fertilizers. Phosphate from agricultural runoff has also been implicated in eutrophication. High use of phosphate in fertilizers has led to unhealthy phosphate levels in many waterbodies. Concentrations as low as 0.02 mg/L phosphate can lead to excessive growth of algae, which in turn leads to reduced water oxygen levels and to the production of toxins, particularly in shallow lakes, estuarine and coastal marine regions. These low oxygen levels and high toxin levels can lead to fish kills and other harm to wildlife.

Ironically, easily-mined, natural phosphorus (P) reserves are limited. Phosphorous reserves, in the form of phosphates, are expected to decline with increasing use of phosphate-based fertilizers.

If phosphate that would otherwise run off agricultural lands could be efficiently recovered, there would be a double benefit: reduced eutrophication in waterbodies, and reduced pressure on dwindling phosphate reserves.

There is an unfilled need for economical, environmentally-friendly technologies to reduce eutrophication and to better manage limited phosphorus reserves. In particular, there is an unfilled need for improved methods for recovering phosphorus from phosphate-enriched waters, such as agricultural runoff. There is an unfilled need for improved methods to treat livestock wastewater, particularly from swine, but also from cattle, poultry, sheep, and other livestock.

Phosphate has been recovered from sewage sludge or sludge ash by dissolution and precipitation methods, with the formation of phosphate mineral precipitates such as struvite.

Adsorption of phosphate is another approach. Adsorbers can be highly selective for phosphate. However, the adsorption approach has had problems including high cost, low renewability, and difficulty in disposing of materials after use. These problems have limited the wider use of traditional adsorbents such as activated carbon and anion exchange resins. Other adsorbents that have been tried include montmorillonite, iron oxides, zeolites, pumice, coir pith, and red mud. However, these adsorbents have typically been effective only under specialized conditions, or only when used in large quantities; and in general they are not cost-effective.

Biochar

Biochar is charcoal made from biomass by pyrolysis, the thermal decomposition of biomass under anoxic conditions. Biochar has been investigated as a potential adsorbent for some pollutants in view of its low cost, environment friendliness, stability, high porosity, ease of preparation, and ease of use. Unfortunately, biochar surfaces normally have a net negative charge, limiting the ability to absorb anions such as phosphate. Metals in biochar (e.g., Al or Fe) can somewhat improve the capacity to adsorb anions, but this enhanced adsorption is limited by the relatively low levels of metals typically found in biomass. Biochar has sometimes been impregnated with metal salts such as AlCl₃, MgCl₂, LaCl₃, or FeCl₃ to enhance anion-absorption capacity. However, even with such enhancements it has proven difficult to efficiently separate the carbon-based particulate adsorbents from the aqueous solution following adsorption.

M. Zhang et al., “Synthesis of porous MgO-biochar nanocomposites for removal of phosphate and nitrate from aqueous solutions,” Chem. Eng. J., vol. 210, pp. 26-32 (2012) discloses MgO-biochar nanocomposites having affinity for removing phosphate and nitrate from water.

Y. Yao et al., “Engineered carbon (biochar) prepared by direct pyrolysis of Mg-accumulated tomato tissues: Characterization and phosphate removal potential,” Bioresource Technology, vol. 138, pp. 8-13 (2013) discloses biochar enriched with magnesium, prepared by hyperaccumulating Mg in live tomato plants during their growth, followed by pyrolysis of harvested tissue. The Mg-enhanced biochar was reported to have better sorption for phosphorus as compared to other tomato leaf biochars.

WO 2013/126477 discloses biochar-metal composites, and their use in removing phosphate, nitrate, and arsenic anions from water.

B. Chen et al., “A novel magnetic biochar efficiently sorbs organic pollutants and phosphate,” Bioresource Technology, vol. 102, pp. 716-723 (2011) discloses magnetic biochar with affinity to remove organic pollutants and phosphate from water, where the biochar is made by precipitating iron on orange peel powder and pyrolyzing it. The resulting biochar evidently had a relatively low phosphate adsorption capacity.

J. Arcibar-Orozco et al., 2012. Effect of phosphate on the particle size of ferric oxyhydroxides anchored onto activated carbon: As(V) removal from water. Environ. Sci. Technol. 46, 9577-9583 describe the addition of PO₄⁻³ (as a capping agent) in forced hydrolysis of FeCl₃ in activated carbon for removing arsenic from water.

W. Liu et al., “Facile synthesis of highly efficient and recyclable magnetic solid from biomass waste,” Scientific Reports, vol. 3, pp. 2419 ff (2013b) describe the conversion of sawdust into a magnetic, porous, carbonaceous solid acid catalyst by an integrated fast pyrolysis-sulfonation process. The catalyst was evaluated for three acid-catalyzed reactions: esterification, dehydration, and hydrolysis.

W. Wu et al., 2008. Magnetic iron oxide nanoparticles: Synthesis and surface functionalization strategies. Nanoscale Res. Lett. 4, 397-415 provide a review of surface-functionalized magnetic iron oxide nanoparticles and their uses.

Y. Seida et al., 2000. Removal of humic substances by layered double hydroxide containing iron. Water Res. 34, 1487-1494 describe the synthesis of iron-based layered double hydroxides containing iron hydroxides, and either magnesium hydroxide or calcium hydroxide. The compositions were tested for their ability to remove phosphate from solution.

Salts such as FeCl₃, ZnCl₂ and MgCl₂ have been used in producing activated carbon, to produce more pores and to give the carbon a higher specific surface area.

### SUMMARY OF THE INVENTION

We have discovered novel composite particles comprising magnesium oxide, iron oxide, and biochar; and methods of making and using the novel composite particles. We have successfully used the novel particles to recover phosphate and other solutes from aqueous solution. We have successfully used the recovered phosphate as a fertilizer that has enhanced plant growth. The novel particles are inexpensive to manufacture and use, and they are environmentally friendly. They may be used to remove phosphate and other solutes from agricultural runoff, wastewater, and surface water. The novel composites possess magnetic properties that enhance their recovery following phosphate adsorption. By contrast, previously-used phosphate adsorbents have either lacked magnetic separation characteristics, or they have had much lower phosphate adsorption capacity than that of the novel composites, or both. There has previously been no adsorbent that has both the magnetic separation properties and the phosphate-absorption properties of the novel biochar composites. The composite particles may be used in recovering other water-soluble ionic pollutants as well, such as nitrate, ammonium, and dissolved organic compounds.

In a successful prototype demonstration, locally available (Louisiana) harvest trash biomass from sugarcane was impregnated with a solution of ferrous chloride and magnesium chloride, and then pyrolyzed at 550° C. The resulting composite particles efficiently absorbed phosphate from aqueous solution, after which they were successfully recovered magnetically, and successfully used as a phosphate fertilizer that enhanced plant growth.

Simply adding iron and magnesium salts to biochar would not have achieved the same results, as the most likely outcome would have been a Mg/Fe layered double hydroxide. We have found that properly sequencing the addition of magnesium and iron is important in making effective adsorbers with magnetic properties.

The novel compositions also enhance adsorption of ammonium through the formation of struvite, by buffering the pH to favor struvite formation. The compositions also adsorb dissolved organic compounds. Although nitrate adsorption had not yet been tested as of the filing date of the provisional priority application, we also expect the novel compositions to adsorb nitrate.

Biochar derived from other agricultural or forestry sources known in the art can be used in practicing the invention; we have obtained particularly good results with sugarcane harvest residue.

The novel MgO-impregnated magnetic biochar (MMSB) particles were compared to unmodified sugarcane harvest residue biochar (SB), and also with magnetic biochar lacking Mg (MSB). The results showed that greater Mg levels in MMSB greatly improved phosphate adsorption as compared to either SB or MSB. For example, a 20% Mg-impregnated MMSB (20 MMSB) successfully recovered more than 99.5% phosphate from aqueous solution. The phosphate adsorption capacity of 20 MMSB was 121.25 mg P per gram of MMSB at pH 4; and only 37.53% of the adsorbed phosphate was desorbed by a 0.01 mol/L HCl solution. XRD and FTIR analysis suggested that phosphate sorption mechanisms involved predominately surface electrostatic attraction and precipitation, with impregnated MgO and surface inner-sphere complexation with iron oxide. The 20 MMSB particles exhibited both strong phosphate sorption and strong magnetic separation ability. The MgO-decorated magnetic biochar could be easily separated with a magnet. The phosphate-loaded 20 MMSB particles also significantly enhanced plant growth, and can be used as a phosphate-based fertilizer.

### BRIEF DESCRIPTION OF THE DRAWINGS

FIG. 1 depicts measurements of the magnetic response of MSB and 20 MMSB.

FIG. 2 depicts the effect of solution pH on phosphate adsorption.

FIG. 3 depicts two the fit of two models for P adsorption to experimental measurements.

### MODES FOR CARRYING OUT THE INVENTION

Materials and Methods

### Example 1. Materials Collection and Biochar Preparation

Sugarcane harvest residue (SHR) was collected at the Louisiana State University AgCenter Sugar Research Station at St. Gabriel, La., United States. SHR comprises primarily leaves and tops of stalks. Sugarcane bagasse, or other sources of biomass, can also be used in the novel process as alternatives to, or in addition to sugarcane harvest residue. The SHR was cut into small pieces, less than about 5 cm, and was washed several times with deionized water (DW) (18.2 MΩ) to reduce dust. The cut, washed SHR was then oven-dried at 55° C. overnight.

The biomass is processed so that a majority of the biomass particles (by mass) preferably have a length (longest dimension) less than 1 mm; more preferably less than 0.5 mm; and most preferably less than 0.2 mm. In these prototype experiments, the oven-dried residue biomass was crushed with a high-speed rotary cutting mill, passed through a 0.12 mm screen, and then used for biochar preparation.

Ferrous chloride, magnesium chloride, sodium phosphate monobasic monohydrate, sodium hydroxide, nitric acid, sulfuric acid, and hydrogen peroxide, all of analytical grade, were purchased from Fisher Scientific (Pittsburgh, Pa., USA). All aqueous solutions were prepared with DW.

The MMSB was prepared by a combined impregnation-pyrolysis procedure. Briefly, 50 grams of SHR were added to a flask containing 500 mL ferrous chloride solution. (Alternatively, a mixture of ferrous and ferric chlorides may be used, for example in a 1:1 molar ratio.) After 6 h shaking at room temperature, the mixture was transferred to an oven at 80° C. until visible supernatant had evaporated. The residue was then dried at 120° C. for 3 h. Then 500 mL of magnesium chloride solution in one of several selected concentrations was added, and the mixture was shaken in a constant temperature oscillator at 120 rpm for 6 h. at 25° C. It is preferred (but optional) to dry the biomass before impregnating it with the metal salts. It is strongly preferred to impregnate the biomass particles with iron first, before magnesium is added, so that the magnesium is predominantly located on the surface where it can better interact with phosphate. Also, adding iron before magnesium helps promote the formation of ferrimagnetic Fe₃O₄ within the biochar composites; other forms of iron oxides, iron hydroxides, and mixed oxides or hydroxides do not have the desired ferrimagnetic properties that Fe₃O₄ possesses. Although some fraction of other oxides, hydroxides, or mixtures may indeed be present in the composition, it is preferred to use reaction conditions that favor the formation of ferrimagnetic Fe₃O₄.

The mixtures were then heated at 80° C. until visible supernatant had evaporated, after which the mixtures were dried at 105° C. for 3 h. Before pyrolysis, each dried mixture was transferred to a porcelain crucible and placed in a muffle furnace under N₂ flow at 400 mL/min for 30 min to remove oxygen from the system. The mixture in the muffle furnace was then heated at an increasing temperature (10° C./min) to 550° C., and the temperature was thereafter maintained at 550° C. for 1 h, all under N₂ flow of 200 mL/min. The resulting biochar product was then gently crushed and passed through a 0.12 mm nylon sieve before characterization. Biochars were made both with and without the magnesium salt addition.

The designation “SB” is sometimes used as a label to designate sugarcane biochar without added Mg or Fe; “MSB” denotes magnetic biochar without magnesium; “MMSB” denotes magnetic biochar with magnesium; and “xMMSB” designates magnetic biochar (i.e., MMSB) containing x percent Mg by mass.

### Example 2. Sample Characterization

Infrared spectra of biochar samples were obtained with a Nicolet iS50 Fourier transform infrared spectrometer (FTIR) (USA). XPS (X-ray photoelectron spectroscopy) spectra were obtained with a Kratos (Japan) AXIS Ultra DLD spectrophotometer using an Al K X-ray source (1486.6 eV photons). The C, H, and N content of the samples was characterized with an elemental analyzer (Elementar Analysen Systeme GmbH, Germany). After biochar samples were digested with concentrated sulfuric acid and hydrogen peroxide, their Mg and Fe fractions were measured by inductively coupled plasma-atomic emission spectrometry (ICP-AES, SPECTRO Plasma 3200, Germany). Magnetization curves for the samples were measured with a PPMS-9T vibrating sample magnetometer (VSM) (Quantum Design, USA) with a varying applied field±15,000 Oe at 298° K. Pore and surface characteristics of the samples were measured by N₂ adsorption at 77° K using a V-Sorb 2800P analyzer (App-one, China). The BET surface area (SBFT) and average pore radius (APR) were evaluated by multipoint BET analysis of adsorption data points with relative pressures of 0.05-0.3 by the BJH method. The total pore volume (TPV) was estimated from a single N₂ adsorbed point at a relative pressure of about 0.99. The microscopic features and morphologies of the samples were characterized using a field emission gun scanning electron microscope (FEG-SEM, JEOL 6335F, Japan) via energy-dispersive X-ray (EDX) spectroscopy and transmission electron microscopy (JEOL 200CX TEM, Japan). X-ray diffraction (XRD) analysis was carried out to identify any crystallographic structure in the samples using a computer-controlled X-ray diffraction meter (Philips Electronic Instruments, Mahwah, N.J., USA).

### Example 3. Batch Adsorption Tests

Batch experiments were conducted to examine and compare the adsorption efficiencies of SB, MSB, and MMSB in recovering phosphate from aqueous solution. Experiments examined phosphate adsorption as a function of both Mg content and aqueous pH. Other experiments examined the adsorption of pollutants, and the desorption of phosphate. In a typical experiment, 0.05 g of adsorbent was added to a polyethylene centrifuge tube containing 20 mL of 50 mg/L solution that had been diluted from a 1000 mg/L phosphate stock solution. The pH of the solution was adjusted between 3.0 and 10.9 using 0.1 mol/L HNO₃ or NaOH before the centrifuge tubes were placed in a shaker operating at 120 rpm and 23.0±0.2° C. All experiments were performed in triplicate. After overnight mixing, each sample was filtered through a 0.22 μm GE cellulose nylon membrane filter. The concentration of phosphate in each filtrate was analyzed with a Thermo Scientific EVO 60 spectrophotometer (USA) at 880 nm (as recommended by the EPA). The adsorption capacity (qₑ, mg/g) of the sorbent material for P was calculated by mass balance per Equation (1) below. (Note: Throughout the specification and claims, the capital letter P, standing alone, refers to phosphorus rather than to phosphate. Masses or mass fractions of “P” refer to the masses or mass fractions of phosphorus per se, rather than of phosphate.)

qₑ=V(Cᵢ-Cₑ)/m (1)

where Cᵢ and Cₑ are the initial and equilibrium concentration of phosphate in solution (mg/L), respectively; V is the volume of solution (L) and m is the sorbent mass (g).

### Example 4. Sorption Isotherms

Our experiments found that SB and MSB had only limited ability to adsorb phosphate, while MMSB had excellent phosphate adsorption ability. A preferred embodiment is 20 MMSB. 20 MMSB was the adsorbent used in the phosphate adsorption isotherm study. The phosphate adsorption capacity of 20 MMSB was examined at pH 4 at phosphorus concentrations varying from 5 to 500 mg/L at 23.0±0.2° C., using the procedures otherwise described above for the batch experiments. Two different isotherm models were compared to the experimental data. The most pertinent equations from the two models can be expressed as:

Langmuir model: qₑ=KQCₑ/(1+KCₑ) (2)

Freundlich model: qₑ=K_{f}Cₑⁿ (3)

where K represents the Langmuir bonding term, which is related to interaction energies (L/mg); K_{f} represents the Freundlich affinity coefficient (mg⁽¹⁻ⁿ⁾Lⁿ/g); Q denotes the Langmuir maximum adsorption capacity (mg/g); Cₑ is the equilibrium solution concentration (mg/L) of the sorbate; and n is the Freundlich linearity constant.

### Example 5. Desorption Study

For the desorption study, phosphate was first adsorbed; the amount adsorbed was measured; then phosphate was desorbed; and the amount desorbed was measured. First, 0.10 g adsorbent was added to a 50 mL centrifuge tube with 40 mL phosphate solution (50 mg phosphorus/L), and the mixture was shaken on a shaker at 120 rpm overnight. The phosphate-loaded adsorbent was then separated from the supernatant by centrifuge, and the supernatant was analyzed for phosphate using the spectrophotometric procedure otherwise described above. For desorption, the phosphate-loaded adsorbent was added to 10 mL of desorption reagent (0.01 mol/L HCl solution) and shaken for 4 h, the supernatant was separated, and the supernatant was analyzed for phosphate to calculate the amount desorbed. The desorption rate was calculated by dividing the desorbed amount by the amount originally adsorbed.

### Example 6. Growth Experiments

Soil samples were collected from the campus of Northwest A&F University (Shaanxi Province, China) at a depth of 0-20 cm. Soil samples were air-dried in the laboratory, visible plant residues were discarded, and the soil was ground to pass through a 2 mm nylon sieve. The physico-chemical properties of the soil samples were: pH 8.66, 45.22% clay particles (<0.01 mm), 1.12 g/kg organic matter, 265 μS/cm electrical conductivity, 1.05 g/kg total nitrogen, 2.38 mg/kg nitrogen as NH₄⁺, 5.62 mg/kg nitrogen as NO₃⁻, 11.6 mg/kg Olsen-P, and 173.6 mg/kg available K.

Growth experiments in pots followed the procedures otherwise described in: R. H. Li et al., “Nutrient transformation during aerobic composting of pig manure with biochar prepared at different temperatures,” Environ. Technol. Vol. 36, 815-826 (2015). Briefly: pots (height 12 cm, bottom 7 cm, mouth 10 cm) were washed with DW before the experiment. The SB and phosphate-loaded 20 MMSB samples were added to the soil at 1% wt application rates. A control treatment used unamended soil. Treatment pots and control pots containing 200 g soil were incubated for 7 days at ˜60% field capacity (i.e., soil moisture). Then ten seeds of ryegrass were planted in each pot, and the resulting plants were grown in a greenhouse at controlled temperature (18˜20° C.) and humidity (55˜60%). After 21 days, plant heights of the ryegrass seedlings were recorded, and the above-ground growth was harvested. The above-ground dry biomass weights were determined following oven drying at 55° C. for 24 h.

### Results and Discussion

### Example 7. Characterization of Adsorbents

Elemental compositions and other sample properties are given in Table 1. The carbon content decreased from 66.28% to 26.23%, proceeding down the rows of the table from SB to 20 MMSB, while Mg content increased from 0.44% to 20.47%. BET surface area analysis measured the S_{BET} of SB and MSB as 24.59 m²/g and 92.54 m²/g, respectively. The higher S_{BET} of MSB was attributed to the iron and magnesium salts impregnated into the sugarcane residue biomass powder before pyrolysis. As magnesium was added, the SBET of MMSB initially increased to 118.03 m²/g at lower Mg concentrations, and then decreased to 27.22 m²/g with increasing Mg content over the range 2.12% to 20.47%. With increasing Mg content, the TPV (total pore volume) of the samples increased from 0.038 cm³/g to 0.343 cm³/g; and APR (average pore radius) increased from 1.78 nm to 4.32 nm—possibly because larger pores were produced with increased metal salt content, or possibly because the biochar surface was covered by metal oxides formed during dehydration.

TABLE 1
Physico-chemical properties of the raw material and biochar

| | | | | | | | | APR |
|---|---|---|---|---|---|---|---|---|
| Material | Fe (%) | Mg (%) | C (%) | H (%) | N (%) | S_{BET} (m²/g) | TPV (cm³/g) | (nm) |
| SHR | ND | ND | 45.85 ± 0.22 | 6.16 ± 0.17 | 0.55 ± 0.02 | ND | ND | ND |
| SB | 0.76 ± 0.02 | 0.44 ± 0.02 | 66.28 ± 1.68 | 2.15 ± 0.02 | 0.90 ± 0.02 | 24.59 | 0.038 | 1.78 |
| MSB | 3.21 ± 0.06 | 0.43 ± 0.03 | 64.33 ± 1.86 | 1.77 ± 0.14 | 1.07 ± 0.02 | 92.54 | 0.101 | 2.07 |
| 2MMSB | 3.23 ± 0.10 | 2.12 ± 0.10 | 61.52 ± 0.44 | 1.54 ± 0.08 | 1.87 ± 0.06 | 118.03 | 0.096 | 1.96 |
| 5MMSB | 3.22 ± 0.05 | 5.04 ± 0.03 | 58.45 ± 0.83 | 1.51 ± 0.06 | 1.74 ± 0.03 | 73.95 | 0.130 | 2.72 |
| 8MMSB | 3.22 ± 0.06 | 8.21 ± 0.22 | 46.14 ± 0.09 | 1.43 ± 0.08 | 1.92 ± 0.04 | 61.39 | 0.157 | 3.51 |
| 15MMSB | 3.21 ± 0.04 | 14.97 ± 0.13 | 40.05 ± 0.17 | 2.17 ± 0.05 | 2.11 ± 0.01 | 35.66 | 0.282 | 3.74 |
| 20MMSB | 3.21 ± 0.06 | 20.47 ± 1.66 | 26.23 ± 0.72 | 2.37 ± 0.09 | 1.52 ± 0.03 | 27.22 | 0.343 | 4.32 |

SHR, sugarcane harvest residue
SB, biochar made from SHR
MSB, magnetic biochar made from SHR
xMMSB, magnesium magnetic biochar made from SHR with Mg percentage x as indicated.
ND = not determined

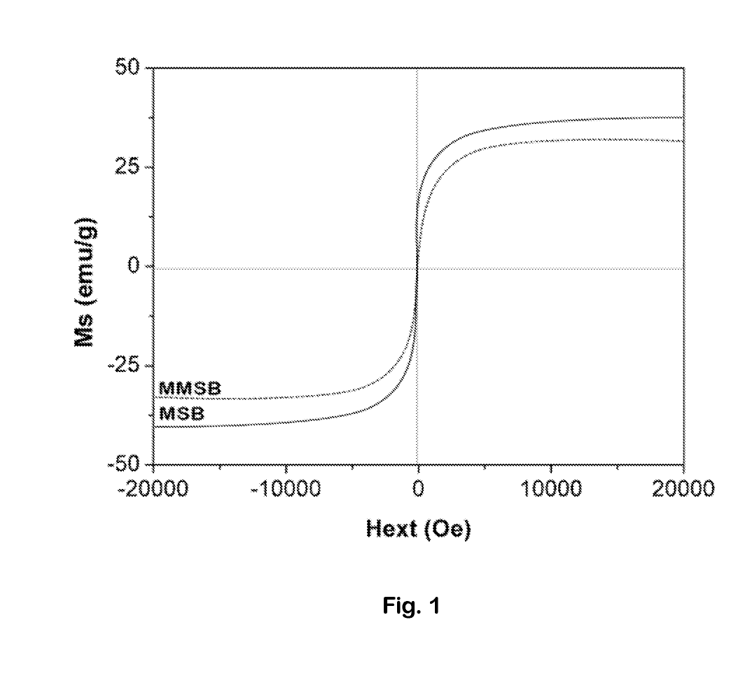

The magnetization properties of the samples were tested at room temperature; results are shown in FIG. 1. The saturated magnetizations of MSB and of 20 MMSB were measured as 42.86 emu/g and 35.35 emu/g, respectively. MSB and 20 MMSB were easily attracted by a magnetic field. By contrast, SB had no observable magnetic response. Even after immersion in water for 5 months, MSB and 20 MMSB samples could still be effectively collected by a magnet (see FIG. S1 of the Supplemental Information in the priority application, incorporated by reference but not reproduced here). These observations confirmed the excellent magnetic abilities of MSB and 20 MMSB in aqueous solution. To determine whether any Fe or Mg dissolved from the MSB or 20 MMSB during adsorption, 0.05 g samples of MSB and 20 MMSB were each immersed in 20 mL DW, adjusted to pH 3.0 or 11.0, for 24 h. Analysis of the supernatant showed that Fe and Mg were strongly bound in the biochar matrix, with undetectable levels of Fe or Mg in any of the supernatants (data not shown). These experiments demonstrated the excellent stability of both the MSB and 20 MMSB samples in both acidic and alkaline environments. This stability in different environments is important for actual use of the novel composites under field conditions.

The surface morphologies of SB, MSB, and 20 MMSB were characterized by SEM and EDX analysis. In general, the particles of SB showed smooth surfaces with sharp edges and corners, while the surfaces of MSB and 20 MMSB particles were very coarse, with some metal oxides covering the surface homogeneously (see FIGS. S2a-c of the Supplemental Information in the priority application, incorporated by reference but not reproduced here). Further, the 20 MMSB showed high EDX peaks for carbon, oxygen, magnesium, and iron, resulting from the elemental composition of the salts used in impregnating the SHR (see FIG. S2d of the Supplemental Information in the priority application, incorporated by reference but not reproduced here). Silicon, a common element in sugarcane residue, was also seen in the EDX pattern of the 20 MMSB sample. On the other hand, the TEM images clearly showed Fe₃O₄ particles around 12-40 nm embedded into the carbon matrix of the MSB sample, and MgO and Mg(OH)₂ crystals covering the surface of the 20 MMSB sample, observations that were confirmed by XRD analysis (see FIG. S3a-d of the Supplemental Information in the priority application, incorporated by reference but not reproduced here).

Without wishing to be bound by this hypothesis, the formation of iron and magnesium oxides during pyrolysis at 550° C. may have resulted from a mechanism such as the following: When the metal-preloaded sugarcane residue thermally decomposed, the biomass turned into solid carbonaceous particles; the produced volatile components were swept out by the flowing N₂ gas; and the ferric and magnesium salts dehydrated. Fe₃O₄ likely formed through the reaction sequence FeCl₂→FeCl₃→Fe(OH)₃→FeO(OH)→2Fe₃O₄, with the gases HCl, H₂O, and CO₂ released in succeeding reaction steps. The formation of MgO and Mg(OH)₂ likely occurred through the reaction sequence MgCl₂→Mg(OH)₂→MgO, with the gases HCl and H₂O released.

### Example 8. Effect of Mg Content and Solution pH on Phosphate Adsorption

The level of phosphate adsorption of magnetic biochar was strongly dependent on the level of incorporated Mg (see FIG. S4 of the Supplemental Information in the priority application, incorporated by reference but not reproduced here). Unmodified SB exhibited very low phosphate adsorption capacity (<0.05 mg P/g); adsorption was presumably inhibited by the negative surface charge of unmodified SB. Simply introducing iron to make MSB—even without any magnesium modification—improved the phosphate adsorption capacity to 2.47 mg P/g. The increased adsorption capacity of MSB was greater than what has previously been reported for other magnetic biochars, made for example from orange peel or cotton stalk. Our results suggest that sugar cane residue has a surprising advantage in phosphate adsorption capacity over at least some of other types of biomass, even without the magnesium modification. The phosphate adsorption capacity increased substantially upon Mg loading, with a high phosphate sorption of 19.92 mg P/g for the 20 MMSB (See FIG. S3 of the Supplemental Information in the priority application, incorporated by reference but not reproduced here). The 20 MMSB samples represent a preferred embodiment, and were selected for subsequent evaluation.

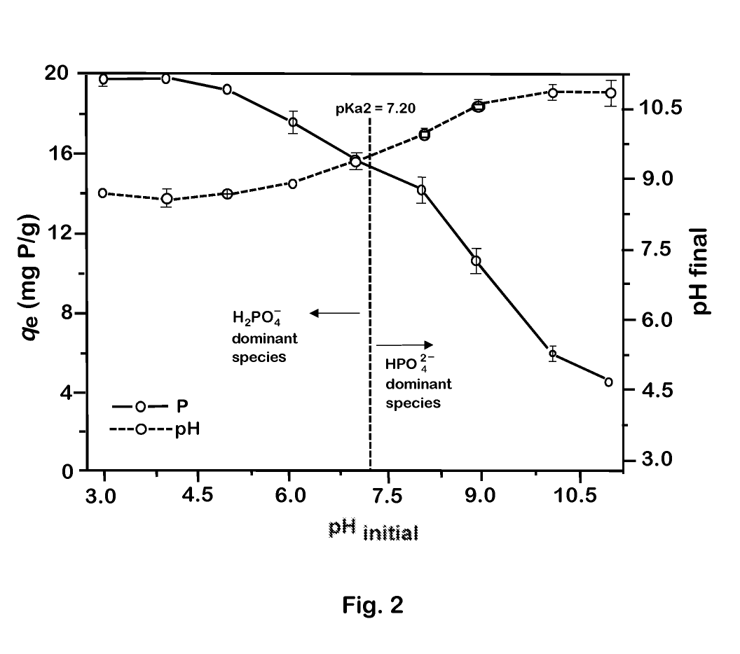

FIG. 2 depicts the effect of solution pH on phosphate sorption by 20 MMSB. Phosphate adsorption gradually decreased from 19.9 mg/g to 4.7 mg/g as pH increased from 3.0 to 10.9. Without wishing to be bound by this hypothesis, the effect of pH on phosphate adsorption may be a consequence both of changes in the aqueous phosphate species at different pH, and changes in the surface properties of the adsorbent as pH changed. Under our experimental conditions, phosphate existed predominantly in the anionic forms HPO₄²⁻ or H₂PO₄⁻ over the pH range 3.0 to 10.9 (FIG. 2). For 20 MMSB at lower pH, Fe and Mg oxides tend to be protonated into the FeOH⁺ and MgOH⁺ forms, which could increase the overall solution pH. The FeOH⁺ and MgOH⁺ groups can act as active sites for HPO₄²⁻ or H₂PO₄⁻ adsorption through electrostatic interactions. Increasing the pH would gradually change the surface charge from positive to negative by deprotonation, resulting in electrostatic repulsion between the negatively charged surface and phosphate anions, and decreasing the overall level of phosphate adsorption.

### Example 9. Adsorption Isotherm and Desorption

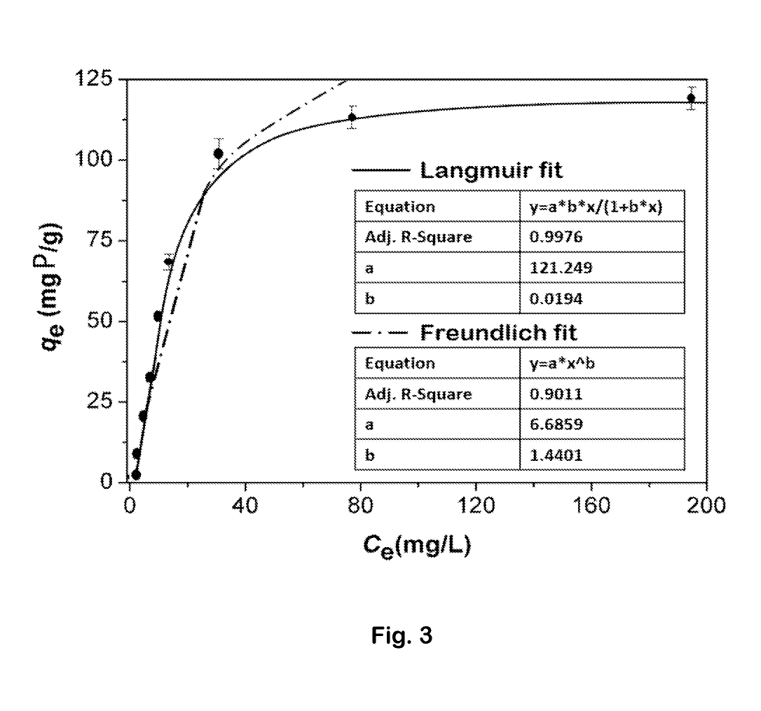

Our batch data for phosphate adsorption with 20 MMSB were fitted to both Langmuir and Freundlich isotherm models. The results, summarized in FIG. 3, showed that phosphate adsorption by 20 MMSB was better described by the Langmuir model (R²=0.9976) than the Freundlich model (R²=0.9011). The highest phosphate adsorption capacity in the initial experiments was 121.25 mg P per gram of modified biochar, much higher than has previously been reported for sorption of phosphate by other magnetic biochars.

We also examined the desorption of phosphate from loaded 20 MMSB particles using different desorption solutions. Only 1.74%, 5.55%, 9.64%, and 37.53% of the total adsorbed phosphate was released by deionized water, NaCl, Na₂CO₃ and HCl solutions, respectively (see FIG. S5 of the Supplemental Information in the priority application, incorporated by reference but not reproduced here). The generally low phosphate desorption rates demonstrated the strong interaction between adsorbate and adsorbent.

### Example 10. Adsorption Mechanisms

The 20 MMSB samples before and after phosphate adsorption were characterized by FTIR spectroscopy and XRD analysis. The FTIR spectra of these samples are shown in FIG. S6 of the Supplemental Information (in the priority application, incorporated by reference but not reproduced here). A broad FTIR band centered around 3448 cm⁻¹ was associated with —OH stretching vibrations in Mg(OH)₂ or the sorbed water molecules, and a peak around 1630 cm⁻¹ was associated with H—O—H bending. A benzene ring C═C stretching peak at 1460 cm⁻¹ suggested that aromatization had occurred during pyrolysis. Peaks around 900-1000 cm⁻¹ were assigned to the stretching and bending vibrations of Mg—O and Mg—OH. A strong peak at 585 cm⁻¹ was attributed to Fe—O lattice vibrations in Fe₃O₄. Following phosphate adsorption, peaks at 870 and 770 cm⁻¹, corresponding to Fe—OH vibrations, nearly disappeared; and a peak appeared around 1050 cm⁻¹, corresponding to asymmetric vibration of the P—O bond, implying an interaction between Fe—OH groups and phosphate ions, and also the possible formation of surface inner-sphere complexes. The strength of the Fe—O lattice vibration peak at 585 cm⁻¹ decreased following phosphate adsorption, but was still readily observed. The appearance of a peak around 1050 cm⁻¹ in the 20 MMSB sample after P adsorption, corresponding to a P—O bond, differed from what had been reported for tomato tissue-derived MgO-impregnated biochar before and after phosphate sorption, suggesting that Fe—O contributed to binding the phosphate groups. (Yao et al., 2013 did not observe any change in the P—O bond.) On the other hand, only a small change was seen in Mg—O and Mg—OH peaks at 900-1000 cm⁻¹ before and after phosphate sorption, suggesting the likely formation of only outer-sphere surface complexes between surface MgO and phosphate (Mg—O—P).

XRD analysis provided additional information about the nature of the phosphate interactions with magnetic MgO-impregnated biochar. The phosphate-loaded 20 MMSB gave strong signals not only for Fe₃O₄ and MgO, but also for newly-formed crystals of MgHPO₄ and Mg(H₂PO₄)₂, indicating a precipitation between phosphate ions and Mg oxide (see FIG. S7 of the Supplemental Information in the priority application, incorporated by reference but not reproduced here).

Taking all these observations into account, and not wishing to be bound by this interpretation, we propose that phosphate adsorption by 20 MMSB was predominantly controlled by a combination of protonation effects, surface inner-sphere complexation, surface electrostatic attraction, and precipitation (see FIG. S8 of the Supplemental Information in the priority application, incorporated by reference but not reproduced here). At pH 4.0 to 9.6, phosphate existed primarily as HPO₄²⁻ and H₂PO₄⁻, and surface electrostatic attraction between phosphate ions and protonated MgOH⁺ presumably predominated. At higher pH, precipitation occurred between phosphate ions and MgO particles, producing MgHPO₄ and Mg(H₂PO₄)₂ crystals on the carbon surfaces. As pH increased from 8.5 to 10.9, phosphate adsorbed strongly, consistent with the hypothesis that precipitation was the predominant mechanism. Phosphate also formed inner-sphere surface complexes with Fe oxide in biochar, but this reaction likely was less significant than Mg-phosphate precipitations, considering the high content of impregnated MgO in the 20 MMSB.

### Example 11. Phosphorus-Loaded Adsorbent as Plant Fertilizer

The potential recycling and use of phosphate-loaded 20 MMSB as a phosphate fertilizer for plant growth was assessed in experiments on ryegrass seedling growth in pots. The phosphate-loaded 20 MMSB amendment resulted in much greater plant growth heights than the SB or control treatment (see FIG. S9 of the Supplemental Information in the priority application, incorporated by reference but not reproduced here). The above-ground biomass dry weight of ryegrass seedlings with the phosphate-loaded 20 MMSB treatment was 1.124 g/pot, significantly higher than that seen with the SB-only treatment (0.613 g/pot) or control (0.367 g/pot). These preliminary plant-growth results strongly suggest that the novel MMSB formulations, such as 20 MMSB, can be used as effective phosphate fertilizers.

Conclusions from Prototype Experiments

The biochar with 20% Mg content (20 MMSB) showed high phosphate recovery capacity, around 121.25 mg P/g at pH 4.0. The adsorption isotherm fitted a Langmuir model well. We inferred that the adsorption process was likely controlled by surface electrostatic attraction with MgO, surface inner-sphere complexing with iron oxide(s), and Mg-phosphate precipitation reactions. Phosphate-loaded 20 MMSB exhibited excellent magnetic recovery ability and limited phosphate desorption. Application of phosphate-loaded 20 MMSB significantly enhanced ryegrass growth. The novel formulations can be used as phosphate-based fertilizer for agronomic production.

### Example 12. Simultaneous Capture Removal of Phosphate, Ammonium, and Organic Compounds

In this set of experiments, adsorption of ions and organic substances was tested in particles without ferrimagnetic properties, because they lacked any significant amount of iron oxide. Iron oxide could also be added to these particles, using methods as otherwise described above, to impart ferrimagnetic properties, and to obtain composite particles having similar adsorption characteristics and also being adapted for magnetic separation.

MgO-impregnated porous biochar was prepared using an integrated adsorption-pyrolysis method, and was then used for absorbing phosphate, ammonium, and organic compounds (humate). Observations revealed that the MgO-biochar contained nano-sized MgO flakes and nanotube-like porous carbon. A 20% Mg-biochar had adsorption capabilities of more than 398 mg/g for phosphate, 22 mg/g for ammonium, and 247 mg/g for humate. The presence of Cl⁻, NO₃⁻, SO₄²⁻, K⁺, Na⁺ and Ca²⁺ ions had no significant effect on humate adsorption; but SO₄²⁻ and Ca²⁺ inhibited phosphate adsorption; and K⁺, Na⁺ and Ca²⁺ inhibited ammonium adsorption. Various characterization measurements suggested that struvite crystallization, electrostatic attraction, and π-π interactions contributed to the adsorption of phosphate, ammonium, and humate. The MgO-biochar can be used for the simultaneous removal and recovery of phosphate, ammonium, and organic substances from waste streams, for example from livestock wastewater.

Sugarcane harvest residue (leafy trash) was obtained from the Louisiana State University Agricultural Center Sugar station at St. Gabriel, La. The biomass was cut into pieces 5 cm or smaller, and the pieces were sequentially washed with tap water and deionized water (DI, 18.2 MΩ) to minimize dust, followed by oven-drying at 55° C. overnight. The dried sugarcane leaves were crushed with a high-speed rotary cutting mill, passed through a 0.12 mm screen, and used for biochar preparation. Swine wastewater was collected from a nearby pig farm. Prior to use, the swine wastewater was pretreated by passing through a 0.22 μm filter membrane to remove suspended solids. Characteristics of this pretreated swine wastewater included: pH 7.86; alkalinity (as CaCO₃), 1377.2 mg/L; COD (chemical oxygen demand), 2080.4 mg/L; total ammonium, 388.1 mg/L; total phosphorus, 91.3 mg/L; K⁺, 173.6 mg/L; Ca′, 21.2 mg/L; and Na⁺, 13.1 mg/L. All reagents—magnesium chloride, sodium phosphate monobasic monohydrate, sodium hydroxide, nitric acid, sulfuric acid, hydrogen peroxide, ammonium chloride, and sodium humate—were of analytical grade, were purchased from Sigma-Aldrich, and were used as received. All solutions were prepared using DI water.

The MgO particle-impregnated porous biochar composite was produced using a modified adsorption and pyrolysis method. Briefly, 50 g of sugarcane crop harvest residue (leafy trash) powder and 1000 mL of MgCl₂ solutions in varying concentrations were mixed in flasks, and the flasks with the mixtures were shaken in a constant-temperature oscillator at 120 rpm for 24 h. The mixtures were heated at 80° C. until the supernatant had evaporated, and the residue was dried at 105° C. for 6 h. Afterwards, each dried mixture was transferred to a porcelain crucible, which was placed in a muffle furnace under N₂ flow at 400 mL min⁻¹ for 30 min to remove air from the system. The mixture in the muffle furnace was then pyrolyzed at 550° C. for 1 h under N₂ flow of 200 mL min⁻¹. After pyrolysis, the resulting biochar products were gently crushed and passed through a 0.12 mm nylon sieve, washed, and oven-dried at 105° C. for 6 h before characterization. Biochars with and without magnesium salt addition were made. For the convenience of discussion, the designation xMg-biochar will sometimes be used to designate MgO-impregnated biochar, where x represents the specific Mg content as a percentage by mass.

The effect of Mg levels on the adsorption of Mg-biochar composite was investigated with phosphate, ammonium, and organic substance solutions. Standard aqueous solutions containing dissolved organic matter were prepared from sodium humate; the DOC (dissolved organic carbon) content of the biochar samples was less than 0.20 mg/L in all cases; therefore, for purposes of evaluating humate adsorption, the dissolved organic content of the biochar samples themselves was neglected. Biochar sorbent samples, 0.05 g each, were mixed with one of a series of 40 mL solutions containing 50 mg/L of phosphate, ammonium, or humate, and placed in centrifuge tubes on a shaker platform operating at 120 rpm for 24 h at room temperature (22.5±0.2° C.). After 24 h shaking, the supernatants were filtered through 0.22 μm nylon membrane filters and analyzed for phosphate, ammonium, and humate by standard methods. Adsorption experiments were performed over an initial pH range of 4.0 to 10.0, and adsorption isotherms were conducted with varying initial concentrations of phosphate (as phosphorus at 1˜500 mg/L), ammonium (5˜200 mg/L) and humate (5˜1000 mg/L). Adsorption kinetics of phosphate, ammonium and humate by the Mg-biochar composite were evaluated by mixing a series of 0.5 g 20% Mg biochar samples with 400 mL phosphate solution (pH 4.03, 50 mg/L phosphorus), 400 mL ammonium solution (pH 7.05, 50 mg/L), or 400 mL humate solution (pH 7.83, 50 mg/L) in plastic bottles. The mixtures were magnetically stirred at 120 rpm at room temperature. At selected times, aliquots of the mixtures were collected, filtered, and analyzed. All adsorption experiments were performed in triplicate.

The effect that one component (phosphate, ammonium, or humate) had on the adsorption of a different component was evaluated by mixing 0.05 g 20% Mg-biochar composite with 40 mL solutions containing 50 mg/L phosphorus (pH 4.01), 50 mg/L ammonium (pH 7.05), or 50 mg/L humate (pH 7.83), and equal concentrations of counter ions (cations and anions) in polyethylene centrifuge tubes. Solutions without added ions were used as control. After overnight equilibration, each mixture was filtered through a 0.22 μm GE cellulose nylon membrane filter, and then analyzed for phosphate, ammonium, and humate concentrations.

To evaluate the effect of the treatment on swine wastewater, adsorption experiments were carried out by mixing 0.25 g biochar adsorbent with 200 mL of swine wastewater in a 250 mL glass flask and shaking for 24 h, using similar procedures. The experiment was repeated three times. After adsorption was complete, the mixtures were filtered, and the filtrates were analyzed for phosphate, ammonium, and humate, and the pH of the filtrate solutions was measured. The loaded (used) biochar adsorbent samples were separated and washed with 10 mL DI water, followed by drying at 105° C. for 6 h before characterization.

Elemental analysis showed a generally increasing Mg content and decreasing C content as the amount of the initial Mg salt increased. XRD analysis revealed that raw biochar without added Mg was dominated by a broad diffraction peak at 2 theta of 23.0°, attributed to the cellulose (002) crystal plane. In the Mg-biochar samples, as the Mg percentage increased the XRD pattern displayed increasing intensity for reflections typical of MgO, with diffraction peaks at 2 theta around 37.1°, 43.1°, 62.5°, 74.7° and 78.6°, attributed to the (111), (200), (220), (311), and (222) lattice planes of MgO, respectively, suggesting the formation of MgO crystallite during the slow pyrolysis process. In addition, Mg-biochar displayed gradually increasing diffraction peaks at 2 theta of 25.8° and 53.5°, attributed to the (002) and (004) lattice planes of carbon nanotubes in the biochar. These results suggest that during the pyrolysis process at 550° C., the MgCl₂·6H₂O underwent a drastic dehydration process to form MgO, while sugarcane residue turned into solid carbonaceous particles.

At higher Mg levels, biochar pore sizes and volume increased significantly, especially around 15-20% Mg, which likely corresponded to the emergence of carbon nanotube-like pore structures in the Mg-biochar. The average pore size (AVP) enlarged from 2.35 nm in 2% Mg-biochar to 22.38 nm in 20% Mg-biochar. MgCl₂ addition did not appear to strongly affect C content.

A clear difference in surface morphology was seen between the original raw biochar (without Mg salt pretreatment) and the Mg-biochar by SEM analysis. As compared with the raw biochar, SEM images clearly showed that MgO particles were deposited on the biochar surface or within the matrix of the 20% Mg biochar. EDX spectrum mapping revealed a uniform C distribution, while Mg was closely associated with O distribution in the Mg-containing biochar. Small peaks for Si, K, and Ca were seen in the EDX spectrum. TEM analysis showed that the surface of raw biochar without MgO was generally smooth, while the ultra-fine 20% Mg biochar composite had homogeneously-deposited MgO flakes across the entire substrate, resulting in a rough and flaky morphology. The calculated average thickness of the MgO flakes ranged from 12 to 28 nm. The TEM images also indicated the presence of carbon nanotube-like pore structures in the 20% Mg-biochar, which was consistent with the observation of the (002) and (004) lattice planes of carbon nanotube in XRD analysis; carbon nanotubes appeared to be absent from the raw biochar without Mg.

As Mg content in the MgO biochar composites increased from 0.44% to 23.07%, ammonium adsorption remained nearly constant (˜20 mg/g). Raw biochar, without MgO impregnation, had very low affinity to adsorb phosphate (<5 mg/g) or humate (<10 mg/g). MgO impregnation enhanced biochar affinity for phosphate and humate by more than 660% and 280%, respectively. The highest phosphate and humate removal (>99.1%) was observed with the 20% Mg-biochar.

The 20% Mg-biochar was used in adsorption isotherm measurements. The 20% Mg-biochar showed stronger affinity for phosphate and humate than for ammonium. For the 20% Mg-biochar, maximum adsorption capacities measured were 398 mg/g for phosphate, 247 mg/g for humate, and 22 mg/g for ammonium. These adsorption capacities were much higher than comparable adsorption capacities that have been previously reported for other adsorbers.

Initial phosphate adsorption was fast, followed by a relatively slower adsorption. Phosphate adsorption increased with extended contact time. More than 99% phosphate was removed within 1 h. The initial rapid adsorption might be due to the electrostatic attraction between the positively-charged magnesium oxide surfaces and the negatively-charged phosphate ions. Modeling suggested that the phosphate adsorption was better described by pseudo-second-order kinetics. The pseudo-second-order model assumes a monolayer adsorption system and adsorption by chemisorption. Humate and ammonium adsorptions were slower, and reached equilibrium at about 8 h and 4 h, respectively. Intra-particle diffusion may better explain the slower adsorption of humate and ammonium, with the pore network and surface of the biochar helping the dispersed MgO flakes interact efficiently with humate and ammonium. The MgO flakes could allow humate and ammonium ions to pass through pores or interstices of the 20% Mg-biochar composite surface, and then enter the negatively-charged carbon matrix by a combined process of intra-particle diffusion and film diffusion.

At pH 4.0, nearly all phosphate was adsorbed by 20% Mg-biochar. Phosphate sorption capacity decreased as the solution pH increased from 4.0 to 10.0, likely in response to diminishing positive charges from MgO on the biochar surface. Humate adsorption capacity increased slightly as pH increased, and then remained more or less constant (˜40 mg/g) above pH 5.5. These observations suggest that humate did not respond as strongly to the surface charge change on the biochar, and instead that an increase in pH favored interaction with the Mg-biochar matrix, perhaps due to better dispersion of a more linear form of humate at higher pH. The Mg-biochar can thus be used as an efficient adsorbent for humate at higher pH. Ammonium adsorption capacity increased as the pH rose from acidic values to 7.0, and then remained more or less constant (˜21 mg/g) at pH 7.0-8.5, suggesting that ammonium was responding to the diminishing positively charged Mg-biochar surface. Above pH 8.5, ammonium adsorption capacity decreased dramatically from 21 mg/g at pH 8.5 to 2.2 mg/g at pH 10, likely due to loss of NH₃ at higher pH.

After adsorption, the final pH for all solutions was around 9.6 to 10.4, indicating that the MgO surface was still positively charged, perhaps due to positive charge development following biochar surface protonation of MgO. This reaction can be described as ≡MgO+H₂O→≡MgOH⁺+OH⁻, resulting an alkaline solution pH. In this study, the initial phosphate solution pH was maintained in the range of 4.0˜10.0 with the negatively charged H₂PO₄⁻ and HPO₄²⁻ as the main species. The MgO on the biochar surface should be positively charged under the experimental conditions, and should exhibit affinity for negatively-charged phosphate at lower pH. Although the positive surface charge of the adsorbent may not favor adsorption of positively-charged ammonium, the ammonium adsorption capacity remained acceptable at pH 7.0-8.5, which may indicate that phosphate and ammonium adsorptions were controlled by different processes.

Various cations and anions that normally coexist in wastewater might potentially interfere with the removal of phosphate, ammonium, and humate by 20% Mg-biochar through competing adsorption. The effect of co-existing substances on phosphate, ammonium, and humate adsorption were tested with solutions having an initial pH of 4.0, 7.0, or 10.0. Compared with control, the presence of Cl⁻, NO₃⁻, SO₄²⁻, K⁺, Na⁺, or Ca²⁺ ions had no significant effect on humate adsorption. The presence of Cl⁻, NO₃⁻, K⁺, or Na⁺ ions did not significantly affect phosphate adsorption by 20% Mg-biochar. SO₄²⁻ led a slight decrease in phosphate removal, perhaps due to competition for the positively-charged site of the adsorbent surface by anions of similar ionic radii: SO₄²⁻ (0.230 nm) and H₂PO₄⁻ (0.238 nm). Ca³⁺ promoted phosphate sorption slightly, perhaps by reacting to form amorphous calcium phosphate. The anions SO₄²⁻, Cl⁻ and NO₃⁻ had no appreciable effect on ammonium adsorption, while equal concentrations of the cations K⁺, Na⁺ and Ca²⁺ competed with ammonium, and decreased the ammonium removal rate from 48.9% to 32.5%.

In tests treating swine wastewater with the 20% Mg-biochar composite, nearly 100% of phosphate, 25.8% of ammonium and 21.0% of COD were removed from the swine wastewater, and the wastewater was significantly clarified. The 20% Mg-biochar composite proved effective in removing phosphate, ammonium, and dissolved organic compounds from sources such as swine wastewater. It may also be used for phosphate and ammonium recovery from nutrient-rich surface waterbodies. It is attractive from both environmental and economic perspectives to use MgO-impregnated porous biochar, derived from the pyrolysis of MgCl₂ preloaded agricultural biomass residue, for contamination control. Low-cost agricultural biomass residue is readily available from many sources. The reagent MgCl₂ is abundant and inexpensive, and can be extracted for example from seawater. While agricultural biomass is readily available from local agricultural processes, many parts of the world still perform open-field burning, causing both resource losses and air quality concerns. The conversion of these biomass wastes into useful products as MgO-impregnated biochar can not only reduce CO₂ emissions and other air pollution issues arising from open field burning, it can also help reduce agricultural solid waste disposal, help clarify livestock wastewater or other wastewater, and also help recover phosphate, ammonium, and organic compounds that can be used as fertilizers to improve crop production. The invention can thus play an important role in resource conservation, nutrient cycling, and sustainable development.

XRD and EDX analyses of the composites after they had treated swine wastewater suggested that the mineral struvite (MgNH₄PO₄.6H₂O) had formed on the MgO-biochar composite surface. An alkaline environment can promote the precipitation of struvite. Dissolving MgO at the composite surface perhaps served as the seeding point for struvite growth, through reactions such as:

MgO+H₂O→Mg(OH)₂→Mg²⁺+2OH⁻

Mg²⁺+HPO₄²⁻+NH₄⁺+6H₂O→MgNH₄PO₄.6H₂O(s)

Ammonium and phosphate ions would be expected to have equal stoichiometric ratios in struvite. However, we observed rather more adsorbed ammonium (˜6 mmol) than phosphate (˜4 mmol) per gram of biochar. Perhaps processes in addition to struvite formation were involved in adsorption of ammonium, such as electrostatic attraction between positive ammonium ion and the inner negatively charged biochar carbon surface.

Dissolved organic compounds are typically adsorbed in the pores: the more porous the carbon particles, the more dissolved organic substances that can be adsorbed. The FTIR spectra of 20% Mg-biochar before and after reacting with swine wastewater were consistent with adsorption of both ammonium and phosphate. We postulate that dissolved organic compounds in swine wastewater pass through the pores or interstices of the 20% Mg biochar composite surface, and come into further contact with the carbon matrix by a combination of intra-particle diffusion and film diffusion, aided by π-π interactions.

A higher ammonium:phosphate molar ratio (3:2) was seen in the adsorbed species than the 1:1 molar ratio that would be expected from struvite [MgNH₄PO₄.6H₂O (s)] formation alone. Additional mechanisms were presumably involved in NH₄⁺ adsorption, such as electrostatic interaction with biochar C matrix. Our results showed the benefits of using MgO-impregnated biochar to recover more NH₄⁺ from wastewater than would result simply from the direct application of Mg salts. We expect the captured ammonium and phosphate to be bioavailable to plants when the adsorbed biochar is used as fertilizer, a prediction that will be tested in future work otherwise similar to the experiments described above for phosphate as fertilizer. In future work we will also test the formation of particles as otherwise described in this example, but possessing ferrimagnetic properties, following procedures as otherwise described above for incorporating iron oxide. We expect the addition of iron oxide in accordance with this invention will permit the adsorbed particles to be magnetically separated, without substantially interfering with the adsorption of ammonium, phosphate, and organic compounds as otherwise outlined in this set of experiments

The novel compositions enhance adsorption of ammonium through the formation of struvite, by buffering the pH to favor struvite formation. Struvite formation is favored by pH in the range 8˜10. A MgO biochar composite (whether or not magnetic) can buffer the wastewater pH within this range due to its alkaline nature, and thereby promote struvite formation. Otherwise, the wastewater pH would generally need to be adjusted to this pH range to promote the formation of struvite to recover phosphate and ammonium from wastewater, for example with NaOH, which would impart additional costs that may be avoided with the present invention.

### MISCELLANEOUS

### Definitions

As used in the claims, where a process is described as comprising certain “sequential” steps (and where like terms are used such as “before,” “after,” “between,” etc.), it should be understood that the specified steps are to be carried out in the order specified. Unless otherwise clearly indicated by context, additional steps may optionally also be carried out, whether before the specified steps, after the specified steps, or interspersed with the specified steps. The specified steps are, however, to be carried out in the order as specified with respect to one another.

A “composite” is an engineered, solid-phase material made from two or more constituent materials with significantly different physical or chemical properties, in which the constituents remain separate and distinct within the finished, solid-phase structure.

The complete disclosures of all references cited in this specification are hereby incorporated by reference. The complete disclosure of priority application 62/362,901 is hereby incorporated by reference. Also incorporated by reference are the complete disclosures of the following publications by the inventors and their colleagues, including the associated Supplemental Information: R. Li et al., “Recovery of phosphate from aqueous solution by magnesium oxide decorated magnetic biochar and its potential as phosphate-based fertilizer substitute,” Bioresource Technology, vol. 215, pp. 209-214 (2016); and R. Li et al., “Simultaneous capture removal of phosphate, ammonium, and organic substances by MgO impregnated biochar and its potential use in swine wastewater treatment,” J. Cleaner Production, vol. 147, pp. 96-107 (2017). In the event of an otherwise irreconcilable conflict, however, the present specification shall control.

### REFERENCES

[1] Ahmad, M., Rajapaksha, A. U., Lim, J. E., Zhang, M., Bolan, N., Mohan, D., Vithanage, M., Lee, S. S., Ok, Y. S., 2014. Biochar as a sorbent for contaminant management in soil and water: A review. Chemosphere 99, 19-33.
[2] Arcibar-Orozco, J. A., Avalos-Borj a, M., Rangel-Mendez, J. R., 2012. Effect of phosphate on the particle size of ferric oxyhydroxides anchored onto activated carbon: As(V) removal from water. Environ. Sci. Technol. 46, 9577-9583.
[3] Chang, J. L., Ma, J. C., Ma, Q. L., Zhang, D. D., Qiao, N. N., Hu, M. X., Ma, H. Z., 2016. Adsorption of methylene blue onto Fe₃O₄/activated montmorillonite nanocomposite. Appl. Clay Sci. 119, 132-140.
[4] Chen, B. L., Chen, Z. M., Lv, S. F., 2011. A novel magnetic biochar efficiently sorbs organic pollutants and phosphate. Bioresour. Technol. 102, 716-723.
[5] Conley, D. J., Paerl, H. W., Howarth, R. W., Boesch, D. F., Seitzinger, S. P., Havens, K. E., Lancelot, C., Likens, G. E., 2009. Controlling eutrophication: Nitrogen and phosphorus. Science 323, 1014-1015.
[6] Desmidt, E., Ghyselbrecht, K., Zhang, Y, Pinoy, L., der Bruggen, B. V, Verstraete, W., Rabaey, K., Meesschaert, B., 2015. Global phosphorus scarcity and full-scale P-recovery techniques: A review. Crit. Rev. Env. Sci. Tec. 45, 336-384.
[7] Gilbert, N., 2009. Environment: the disappearing nutrient. Nature 461, 716-718.
[8] Giménez, J., Martínez, M., de Pablo, J., Rovira, M., Duro, L., 2007. Arsenic sorption onto natural hematite, magnetite, and goethite. J. Hazard. Mater. 141, 575-580.
[9] He, G. X., He, L. H., Zhao, Z. W., Chen, X. Y., Gao, L. L., Liu, X. H., 2013. Thermodynamic study on phosphorus removal from tungstate solution via magnesium salt precipitation method. Trans. Nonferrous Met. Soc. China 23, 3440-3447.
[10] Jeong, C., S. K. Dodla, and J. J. Wang. 2016. Fundamental and molecular composition characteristics of biochars produced from sugarcane and rice crop residues and their by-products. Chemosphere 142: 4-13.
[11] Jiang, C., Jia, L. Y., He, Y. L., Zhang, B., Kirumba, G., Xie, J., 2013. Adsorptive removal of phosphorus from aqueous solution using sponge iron and zeolite. J. Colloid Interf. Sci. 402, 246-252.
[12] Jung, K. W., Ahn, K. H., 2016. Fabrication of porosity-enhanced MgO/biochar for removal of phosphate from aqueous solution: Application of a novel combined electrochemical modification method. Bioresour. Technol. 200, 1029-1032.
[13] Karimaian, K. A., Amrane, A., Kazemian, H., Panahi, R., Zarrabi, M., 2013. Retention of phosphorous ions on natural and engineered waste pumice: Characterization, equilibrium, competing ions, regeneration, kinetic, equilibrium and thermodynamic study. Appl. Surf. Sci. 84, 419-431.
[14] Krishnan, K. A., Haridas, A., 2008. Removal of phosphate from aqueous solutions and sewage using natural and surface modified coir pith. J. Hazard. Mater. 152, 527-535.
[15] Leng, L., Yuan, X., Zeng, G., Shao, J., Chen, X., Wu, Z., Wang, H., Peng, X., 2015. Surface characterization of rice husk biochar produced by liquefaction and application for cationic dye (Malachite green) adsorption. Fuel 155, 77-85.
[16] Li, R. H., Wang, Q., Zhang, Z. Q., Zhang, G. J., Li, Z. H., Wang, L., Zheng, J. Z., 2015. Nutrient transformation during aerobic composting of pig manure with biochar prepared at different temperatures. Environ. Technol. 36, 815-826.
[17] Liu, W. J., Jiang, H., Tian, K., Ding, Y., Yu, H. Q., 2013a. Mesoporous carbon stabilized
MgO nanoparticles synthesized by pyrolysis of MgCl₂ preloaded waste biomass for highly efficient CO₂ capture. Environ. Sci. Technol. 47, 9397-9404.
[18] Liu, W. J., Tian, K., Jiang, H., Yu, H. Q., 2013b. Facile synthesis of highly efficient and recyclable magnetic solid acid from biomass waste. Sci. Rep. 3, 2419-2423.
[19] Loganathan, P., Vigneswaran, S., Kandasamy, J., Bolan, N. S., 2014. Removal and recovery of phosphate from water using sorption. Crit. Rev. Environ. Sci. Technol. 44, 847-907.
[20] Li), J. B., Liu, H. J., Liu, R. P., Zhao, X., Sun, L. P., Qu, J. H., 2013. Adsorptive removal of phosphate by a nanostructured Fe—Al—Mn trimetal oxide adsorbent. Powder Technol. 233, 146-154.
[21] Nguyen, T. A. H., Ngo, H. H., Guo, W. S., Zhang, B. J., Liang, S., Lee, D. J., Nguyen, P. D., Bui, X. T., 2014. Modification of agricultural waste/by-products for enhanced phosphate removal and recovery: Potential and obstacles. Bioresour. Technol. 169, 750-762.
[22] Pei, G. F., Wang, Q., Liu, G. X., 2015. The role of periphyton in phosphorus retention in shallow lakes with different trophic status, China. Aquat. Bot. 125, 17-22.
[23] Ren, J., Li, N., Li, L., An, J. K., Zhao, L., Ren, N. Q., 2015. Granulation and ferric oxides loading enable biochar derived from cotton stalk to remove phosphate from water. Bioresour. Technol. 178, 119-125.
[24] Seida, Y, Nakano, Y, 2000. Removal of humic substances of by layered double hydroxide containing iron. Water Res. 34, 1487-1494.
[25] Tan, X., Liu, Y., Zeng, G., Wang, X., Hu, X., Gu, Y., Yang, Z., 2015. Application of biochar for the removal of pollutants from aqueous solutions. Chemosphere 125, 70-85.
[26] Takaya, C. A., Fletcher, L. A., Singh, S., Anyikude, K. U., Ross, A. B., 2016. Phosphate and ammonium sorption capacity of biochar and hydrochar from different wastes. Chemosphere 145, 518-527.
[27] Tongamp, W., Zhang, Q. W., Saito, F., 2007. Preparation of meixnerite (Mg—Al—OH) type layered double hydroxide by a mechanochemical route. J. Mater. Sci. 42, 9210-9215.
[28] Wang, Z. H., Guo, H. Y., Shen, F., Yang, G., Zhang, Y. Z., Zeng, Y M., Wang, L. L., Xiao, H., Deng, S. H., 2015. Biochar produced from oak sawdust by Lanthanum (La)-involved pyrolysis for adsorption of ammonium (NH₄⁺), nitrate (NO₃⁻), and phosphate (PO₄³⁻), Chemosphere 119, 646-653.
[29] Wu, W., He, Q., Jiang, C., 2008. Magnetic iron oxide nanoparticles: Synthesis and surface functionalization strategies. Nanoscale Res. Lett. 4, 397-415.
[30] Xie, J., Lin, Y., Li, C. J., Wu, D. Y., Kong, H. N., 2015. Removal and recovery of phosphate from water by activated aluminum oxide and lanthanum oxide. Powder Technol. 269, 351-357.
[31] Yan, L. G., Yang, K., Shan, R. R., Yan, T., Wei, J., Yu, S. J., Yu, H. Q., Du, B., 2015. Kinetic, isotherm and thermodynamic investigations of phosphate adsorption onto core-shell Fe₃O₄ @LDHs composites with easy magnetic separation assistance. J. Colloid Interf. Sci. 448, 508-516.
[32] Yao, Y., Gao, B., Inyang, M., Zimmerman, A. R., Cao, X., Pullammanappallil, P., Yang, L. 2011. Removal of phosphate from aqueous solution by biochar derived from anerobically digested sugar beet tailings. J. Hazard. Materi. 190, 5021-507.
[33] Yao, Y., Gao, B., Chen, J. J., Zhang, M., Inyang, M., Li, Y C., Alva, A., Yang, L. Y., 2013. Engineered carbon (biochar) prepared by direct pyrolysis of Mg-accumulated tomato tissues: Characterization and phosphate removal potential. Bioresour. Technol. 138, 8-13.
[34] Ye, J., Cong, X. N., Zhang, P. Y., Hoffmann, E., Zeng, G. M., Liu, Y, Fang, W., Wu, Y, Zhang, H. B., 2015. Interaction between phosphate and acid-activated neutralized red mud during adsorption process. Appl. Surf. Sci. 356, 128-134.
[35] Ye, Z. L., Shen, Y., Ye., X., Zhang, Z. J., Chen, S. H., Shi, J. W., 2014. Phosphorus recovery from wastewater by struvite crystallization: Property of aggregates. J. Environ. Sci. 26, 991-1000.
[36] Yoon, S. Y., Lee, C. G., Park, J. A., Kim, J. H., Kim, S. B., Lee, S. H., Choi, J. W., 2014. Kinetic, equilibrium and thermodynamic studies for phosphate adsorption to magnetic iron oxide nanoparticles. Chem. Eng. J. 236, 341-347.
[37] Zhang, M., Gao, B., 2013. Removal of arsenic, methylene blue, and phosphate by biochar/AlOOH nanocomposite. Chem. Eng. J. 226, 286-292.
[38] Zhang, G. S., Liu, H. J., Liu, R. P., Qu, J. H., 2009. Removal of phosphate from water by a Fe—Mn binary oxide adsorbent. J. Colloid Interf. Sci. 335, 168-174.

What is claimed:

1. A process for making magnesium oxide/iron oxide/biochar composite particles, said process comprising the sequential steps of:
(a) impregnating biomass with aqueous solutions of one or more iron salts and one or more magnesium salts; and
(b) pyrolyzing the iron- and magnesium-impregnated biomass under anoxic conditions to produce composite particles; wherein the composite particles comprise biochar, MgO, and Fe₃O₄.

2. The process of claim 1, wherein the composite particles are ferrimagnetic.

3. The process of claim 1, wherein the biomass comprises sugarcane harvest residue.

4. The process of claim 1, wherein said process additionally comprises the step of drying the biomass before said step of impregnating the biomass with the salts; and wherein the biomass is impregnated with the iron salt before the biomass is impregnated with the magnesium salt.

5. The process of claim 4, wherein the biomass is dried between the iron salt impregnation step and the magnesium salt impregnation step.

6. The process of claim 1, wherein the composite particles have the capacity to adsorb an amount of phosphate equivalent to at least 10% phosphorus by mass of the composite particles.

7. The process of claim 1, wherein the composite particles comprise at least 3% iron by mass, and at least 10% magnesium by mass.

8. Composite particles produced by the process of claim 1.

9. A process for recovering from aqueous solution one or more dissolved solutes selected from the group consisting of phosphate, nitrate, ammonium, and organic compounds; said process comprising the steps of: (a) contacting an aqueous solution containing the one or more dissolved solutes with the composite particles produced by the process of claim 1 for a time sufficient to allow sorption of one or more solutes onto the composite particles; and (b) magnetically separating the sorbed composite particles with the sorbed solutes from the solute-depleted aqueous solution.

10. The process of claim 9, wherein the aqueous solution with the one or more dissolved solutes comprises agricultural runoff, livestock wastewater, or municipal wastewater.

11. A process for enhancing the growth of a plant, said process comprising applying solute-sorbed composite particles produced by the process of claim 10 to a growing plant or to soil in the vicinity of a growing plant, wherein the solute-sorbed composite particles act as a fertilizer for the plant, and wherein the growth of the plant is enhanced as compared to the growth of an otherwise similarly-situated plant in the absence of the solute-sorbed composite particles.

12. A composite particle; wherein said particle has a length less than 1.0 mm; wherein said particle comprises biochar; wherein said particle additionally comprises MgO and Fe₃O₄; wherein said composite particle has the capacity to adsorb at least 10% phosphorus by mass as phosphate; and wherein said composite particle is ferrimagnetic.

13. A plurality of the composite particles of claim 12.

14. A process for recovering from aqueous solution one or more dissolved solutes selected from the group consisting of phosphate, nitrate, ammonium, and organic compounds; said process comprising the steps of: (a) contacting an aqueous solution containing the one or more dissolved solutes with the composite particles of claim 13 for a time sufficient to allow sorption of one or more solutes onto the composite particles; and (b) magnetically separating the sorbed composite particles with the sorbed solutes from the solute-depleted aqueous solution.

15. The process of claim 14, wherein the aqueous solution with one or more dissolved solutes comprises agricultural runoff, livestock wastewater, or municipal wastewater.

16. A process for enhancing the growth of a plant, said process comprising applying the solute-sorbed composite particles of claim 14 to a growing plant or to soil in the vicinity of a growing plant, wherein said solute-sorbed composite particles act as a fertilizer for the plant, and wherein the growth of the plant is enhanced as compared to the growth of an otherwise similarly-situated plant in the absence of said solute-sorbed composite particles.

17. The composite particle of claim 12, wherein said MgO is predominantly located on the surface of said particle.
